(19) United States
(12) Patent Application Publication
(10) Pub. No.: US 2006/0124873 A1
(43) Pub. Date: Jun. 15, 2006

(54) Substrate detector and method for detecting a substrate

(76) Inventor: Yasuhito Anzai, Tokyo (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/284,881

(22) Filed: Nov. 23, 2005

(30) Foreign Application Priority Data
Dec. 10, 2004 (JP) 2004-358706

(51) Int. Cl. G01N 21/86; G01V 8/00

(52) U.S. Cl. 250/559.4

(57) ABSTRACT

The invention relates to a substrate detectors ng a substrate presence/absence regardless of substrate material and also of reducing the size increase in the apparatus. There are included a light emitter for emitting light toward a transport path of the substrate such that the light is obliquely incident upon a surface of the substrate, and a light receiver arranged in a position to receive the light passed the transport path of the substrate. The light receiver includes at least a plurality of sensors arranged in series.

### BACKGROUND OF THE INVENTION

1. Field of the Invention

The present invention relates to a substrate detector and method for detecting a substrate. More particularly, the invention relates to a substrate detector and method for detecting a substrate by being applied to an automated apparatus for handling a substrate, such as a wafer to which various materials are to be applied.

2. Description of the Related Art

Automation is advancing for apparatuses that perform work on substrates, particularly for a semiconductor fabrication apparatus to handle a substrate, such as a wafer. The semiconductor fabrication apparatus uses a transport mechanism for wafer transportation. The transport mechanism has a substrate detector for detecting a wafer in order to know whether a wafer is present or not or to the location of the wafer.

Because of the problem that wafer presence/absence detection, if made by mechanical contact with the wafer, could possibly damage the wafer, it is a usual practice to adopt, for a substrate detector, a method using optical recognition. More particularly, the substrate detector has a light emitter for emitting light toward a wafer and a light receiver for receiving the light. For the transport mechanism, the light emitter and the light receiver are arranged sandwiching a path along which a wafer is to be transported. With such an arrangement, when a wafer is transported, the light emitted from the light emitter is blocked by the wafer. Consequently, the light from the light emitter is not detected by the light receiver, to cause a change in photoelectric conversion of the light detected at the light receiver, thus making it possible to detect the wafer.

The technology concerning such substrate detection includes the disclosures in the following documents.

Silicon is generally used as a material of a wafer for use in manufacturing a semiconductor. Detecting the absence/presence of a wafer is easy when using the above method because silicon is not transmissive to light. However, when sapphire is used as a wafer material, wafer presence/absence is difficult to detect by use of the above method because it is transmissive to light. Various studies have been made on methods to detect a wafer formed by a sapphire substrate, including the technologies described in the following documents.

In the method disclosed in JP-A-6-102361, a reflective photoelectric switch is used. Light is emitted from the light emitter onto a substrate at such an angle that, even if the substrate is transparent, part of the light is reflected by the substrate surface. Due to this, substrate presence/absence is detected, based on the amount of the light reflected by the reflection plate and detected by the light receiver.

In the method disclosed in JP-A-7-283383, a silicon-on-sapphire wafer (hereinafter, SOS wafer) is provided, at its backside, with a layer which prevents sensor light transmit. Thus, detection of the substrate presence/absence is made possible similar to that of the silicon wafer, by forming the SOS wafer to be non-transmissive to sensor light.

### OBJECT AND SUMMARY OF THE INVENTION

The method disclosed in JP-A-6-102361 requires the detecting light to enter a substrate at such an angle that, even if the substrate is transparent, part of the detecting light is reflected upon the substrate surface. Consequently, the arrangement disclosed in JP-A-6-102361, i.e. the photoelectric switch and the reflection plate, must be nearly horizontal relative to the widthwise direction of the substrate (horizontal to the substrate surface). Thus, there is a restriction in a widthwise direction of the substrate because of the arrangement of the photoelectric switch and reflection plate, increasing the size of the detector itself. Otherwise, in setting up the detector, the area required must be larger, resulting in an increased size of the semiconductor fabrication apparatus overall.

In the method disclosed in JP-A-7-283383, although the existing detector can be provided without change, there is a need for a processing to provide such an SOS wafer, at its backside, with a layer for not allowing sensor light to be transmitted. Consequently, a cost increase is inevitably encountered in semiconductor fabrication corresponding to the provision of such a layer to the SOS wafer so as to not allow sensor light to be transmitted. Furthermore, if a thickness of the layer on the backside of the SOS wafer is small partially so as to transmit sensor light, it is impossible to detect wafer presence/absence.

Furthermore, the two patent documents are to merely detect a substrate (wafer) presence/absence, e.g. detection is impossible as to whether the transported wafer is a silicon or sapphire material. Consequently, when a sapphire substrate is transported, even though processing is for a silicon substrate, it cannot be detected.

The present invention comprises: a light emitter for emitting light toward a transport path of the substrate such that the light is obliquely incident upon a surface of the substrate; and a light receiver arranged in a position to receive the light passed the transport path of the substrate; wherein the light receiver is structured with at least a plurality of sensors arranged in series.

The invention also comprises: a light emitter for emitting light toward a position of a peripheral edge of the substrate mounted on a stage such that the light is obliquely incident upon a surface of the substrate; and a light receiver arranged in a position to receive the light passed the position of the peripheral edge of the substrate; wherein the light receiver is structured with at least a plurality of sensors arranged in series.

In the invention, the light received at the light receiver is converted into digital data on a sensor-by-sensor basis, to detect a substrate presence/absence depending upon a converted digital data string.

Furthermore, one of the features of the invention is that the substrate detector has a reflection plate.

Furthermore, one of the features of the invention is that it is also possible to detect a type of substrate and a substrate peripheral edge state depending upon the digital data string.

According to the substrate detector of the invention, by utilizing the light refractive index of a substrate material, substrate presence/absence can be detected depending upon a position of a sensor receiving the light from among a plurality of sensors constituting the light receiver.

Depending upon a position of the sensor that has received the light, it is possible to detect the type (material) the substrate.

Furthermore, because there is no need to cause the incident light on the substrate surface to be reflected, due to detection using the light refractive index of the substrate, there is a reduced restriction in arranging the light emitter and receiver widthwise of the substrate. Thus, it is possible to reduce the size of the detector itself and the size of the semiconductor fabrication apparatus overall.

### BRIEF DESCRIPTION OF THE DRAWINGS

FIG. 1 is a view explaining a substrate detector and a method for detecting a substrate (for substrate presence) according to embodiment one of the present invention;

FIG. 2 is a view explaining a method for detecting a substrate (for substrate absence) according to embodiment one of the present invention;

FIG. 3 is a diagram explaining a processing section for processing a detection result of from the light receiver according to embodiment one of the present invention;

FIG. 4 is a table showing a result that the detection result of from the light receiver is changed into a digital data string, according to embodiment one of the present invention;

FIG. 5 is a view explaining a substrate detector and a method for detecting a substrate (for substrate presence) according to embodiment two of the present invention; and

FIG. 6 is a view explaining a method for detecting a substrate (for substrate absence) according to embodiment two of the present invention.

### DETAILED DESCRIPTION OF THE PREFERRED EMBODIMENTS

By use of the drawings, a description is now made of a substrate detector and method for detecting a substrate in the present invention. The below description is an example based on a wafer to be used in making a semiconductor device, but is not limited thereto. The invention is to be applied without the scope not departing from the gist of the invention, i.e. to those apparatuses for handling the substrates different in material in addition to making a semiconductor device.

### Embodiment One

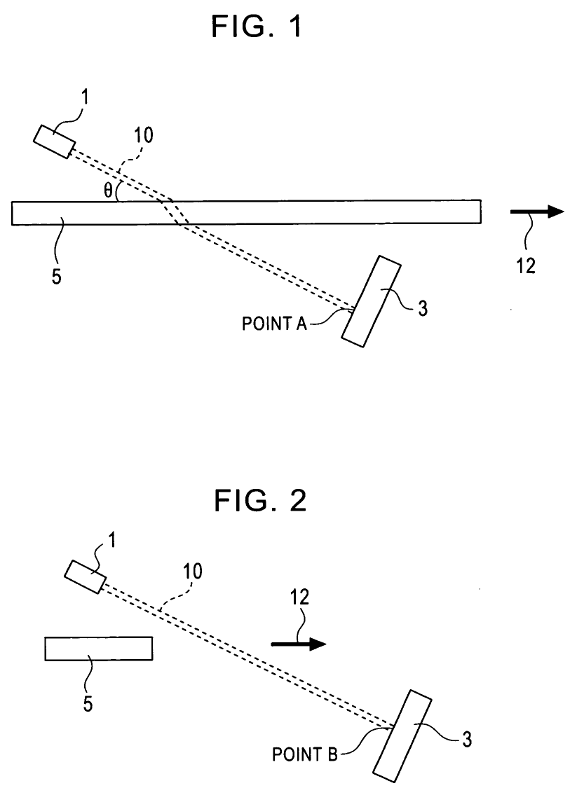

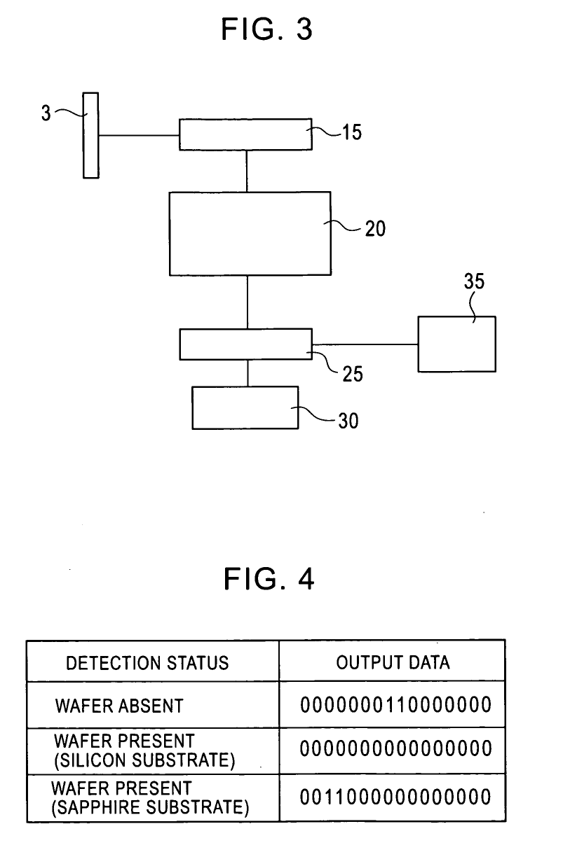

Referring FIGS. 1 to 4, a substrate detector and method for detecting a substrate according to embodiment one is described. FIG. 1 explains a substrate detector and method for detecting the presence of a substrate in embodiment one of the invention. FIG. 2 explains a method for detecting the absence of a substrate in embodiment one of the invention. FIG. 3 explains a processing section for processing the detection result of a light receiver in embodiment one of the invention. FIG. 4 is a table showing a detection result from the light receiver is changed into a digital-data string, in embodiment one of the invention.

In FIG. 1, the substrate detector includes a light emitter 1 and a light receiver 3. The light emitter 1 is to emit light 10, for wafer detection, toward a transport path along which a wafer 5 is to be transported. As shown in FIG. 1, the light 10 from the light emitter 1 obliquely enters the wafer 5 at its surface (surface where circuit elements, etc. are to be formed). The light receiver 3 is arranged in a position to receive the light passed the transport path of the wafer. Namely, in FIG. 1, the light emitter is arranged above the transport path while the light receiver 3 is below the transport path. The light receiver 3 is structured with a plurality of sensors. A plurality of sensors are arrayed in series (in a direction intersecting with a surface of the wafer 5, i.e. in a vertical direction of the light receiver 3 in FIG. 1). The plurality of sensors are each configured by a CCD (charge coupled device). By arranging the sensors in series, a CCD line sensor (also called a linear sensor) is provided.

In this manner, the substrate detector in the invention is arranged to allow the light 10 to obliquely enter the surface of the wafer 5, under transport along the transport path. With this arrangement, the wafer 5 can be detected by using the refractive index of the material of the wafer 5, depending upon a position of the light received by the light receiver 3 (depending upon which one of the sensors arranged in series receives the light). The substrate detecting method of the invention is now described in detail.

It is first assumed that a sapphire wafer that is transmissive to light is being transported in a direction 12 along the transport path. The light 10 emitted from the light emitter 1 obliquely enters the surface of the wafer 5. Because sapphire has a refractive index, in ratio to air, of 1.5-1.6, the light obliquely incident upon the wafer 5 is refracted and propagated in the wafer 5. The refracted light exits the wafer 5 at the backside of the wafer and reaches point A on the light receiver 3. At the light receiver 3, the light is received by the sensor arranged at point A from among the plurality of sensors, i.e. the light is not received by the other sensors. Because the invention utilizes the refractive index based on a wafer material, there is no need to positively reflect, upon the wafer surface, the light 10 from the light receiver 1. Thus, there is no need to decrease the incident angle of light 10 upon the wafer surface (angle θ in FIG. 1). Considering this point, at an incident angle of 60 degrees<θ<90 degrees, the refraction within the wafer is small so that incident light cannot be refracted sufficiently, resulting in a possibility that positive detection is not achieved by the sensor. At an incident angle of 0 degree <θ<30 degrees, light reflection occurs upon the wafer surface to thereby reduce the propagation light in the wafer and hence decrease the light reaching the sensor, thus resulting in a possibility that positive detection is not available at the sensor. Because the arrangement must be nearly parallel relative to the widthwise direction of the substrate (parallel direction to the substrate surface), the physical distance required for detection increases between the light emitter 1 and the sensor, thus increasing the device size. Accordingly, in order to effectively realize the invention, the light emitter 1 is desirably arranged such that the incident angle θ lies in a range of 30 degrees≦θ≦60 degrees, to arrange the light receiver 3 (sensor) in a position to receive the light from the light emitter 1 and the refracted light propagated by the wafer.

As shown in FIG. 2, in the case the wafer 5 is not transport to the transported path, the light 10 emitted from the light emitter 1 reaches the light receiver 3 without being blocked or refracted by the wafer 5. Accordingly, the light reaches point B on the light receiver 3 off the point A.

Although not shown, it is assumed that a wafer whose material is silicon, i.e., not transmissive to light, is being transported in the direction 12 along the transport path. The light 10 emitted from the light emitter 1 obliquely enters the surface of the wafer 5. However, silicon is not transmissive to light where the wafer has a thickness of approximately 600 μm-800 μm. With such a degree of thickness, the incident light 10 can be blocked off almost certainly. Accordingly, the light 10 emitted from the light emitter 1 is blocked off by the wafer 5. Thus, no light reaches the light receiver 3.

In this manner, detection is possible as to the presence/absence of a wafer 5 depending upon a light-receiving state at the plurality of sensors on the light receiver 3 and a position of the sensor that receives the light. Furthermore, detection is also possible as to the material of a wafer 5. In this respect, description is now made in detail.

FIG. 3 shows the processing section for processing the detection result of the light receiver 3. This processing section has a photoelectric converting section 15 for photoelectrically converting the light from the light receiver 3, a digital-data-string generating section 20 for converting the photoelectrically-converted electric signal into a digital-data string, a substrate determining section 25 for determining a wafer presence/absence and wafer type, depending upon the digital-data string generated at the digital-data-string generating section 20, a control section 30 for generating and outputting various control signals (e.g. a signal for preparing for accepting the wafer in to the semiconductor fabrication apparatus) according to a result of the determination at the substrate determining section 25, and a storage section 35.

At first, in the photoelectric converting section 15, the light received at the light receiver 3 is converted into an electric signal. Namely, the outputs from the sensors structuring the light receiver 3 are respectively converted into electric signals. For example, for the sensor that does not receive the light, an output is converted into a ground-level signal as an electric signal whereas, for the sensor that receives the light, the signal is converted into a power-source-level (e.g. 5V, 3.3V or the like) signal as an electric signal. The converted signals are sequentially transferred to the digital-data-string generating section 20 (e.g. in the order of the photoelectrically-converted signals at the sensors from below to above the light receiver 3 in FIG. 1). Because of detecting a wafer presence/absence in a short time, the signals generated by photoelectric conversion at the photoelectric converting section 15 are outputted in a continuous fashion.

The digital-data-string generating section 20 determines whether or not the signal from the photoelectric converting section 15 is equal to or lower than a reference level (e.g. an intermediate level between the ground level and the power voltage level). As mentioned before, because the signals generated due to photoelectric conversion at the photoelectric converting section 15 if continuously output the signals become one unified signal, sampling is performed a plurality of times (e.g. a number of times corresponding to the number of sensors) in predetermined sampling timing on the signals from the photoelectric converting section 15, to execute the determination process on the signal levels in the sampled timing. In the invention, an explanation is based on the assumption, as an example, that there are sixteen sensors and sampling is performed sixteen times. In the case the signals in a sampled portion have a level higher than the reference level, the determination is “1”. When the signals in a sampled portion have a level equal to or lower than the reference level, the determination is “0”. Such a determination result of sampling gives a digital-data string to be outputted to the substrate determining section 25. Here, in FIG. 4, is shown a table showing a result that the detection result from the light receiver 3 is changed into a digital-data string in the digital-data string generating section 20.

In FIG. 4, the digital-data string, based on a detection result from the light receiver 3 in the absence of a wafer (in the FIG. 2 case), is given as a 16-bit digital-data string “0000000110000000”. In this case, in the absence of a wafer, the light from the light emitter 1 reaches point B on the light receiver 3 as mentioned above. The bit in a portion corresponding to a detection result at the sensor corresponding to the point B is “1” while the other bits corresponding to a detection result at the sensor that does not received the light is “0”. Namely, the data on the 8th and 9th bits (in the description, the 16-bit digital-data string is assumed to have a left-end bit defined as the 1st bit and a right-end bit defined as the 16th bit) corresponds to a detection result at the sensor arranged at point B on the light receiver 3 of FIG. 2.

Likewise, in the case of a wafer whose material is silicon, “0000000000000000” is given as a 16-bit digital-data string. This is because, for the wafer whose material is silicon, the light from the light emitter 1 does not reach the light receiver 3 because it is blocked by the wafer as mentioned above. For this reason, the bit corresponding to a detection result at every sensor not received the light is “0”.

In the case of a wafer whose material is sapphire, “0011000000000000” is given as a 16-bit digital-data string. This is because, for the wafer whose material is sapphire, the light from the light emitter 1 propagates with a refraction at the wafer thus reaching point A on the light receiver 3. The bits, in a portion corresponding to a detection result at the sensors corresponding to the point A, are “1” while the other bits, corresponding to a detection result at the sensors that do not receive the light, are “0”. Namely, this means that the data at the 3rd and 4th bits corresponds to a detection result of the sensors arranged at point A on the FIG. 1 light receiver 3.

The substrate determining section 25 is to determine a substrate presence/absence depending upon a digital-data string. Here, the storage section 30 previously stores, in its memory, a 16-bit digital-data string (“0000000110000000”) to be generated in the absence of a wafer, a 16-bit digital-data string (“0000000000000000”) to be generated in the case of detecting a wafer whose material is silicon, and a 16-bit digital-data string (“0011000000000000”) to be generated in the case of detecting a wafer whose material is sapphire. Comparison processing is made between a digital-data string outputted from the digital-data-string generating section 20 and a digital-data string stored in the storage section 35. Based upon a result of the comparison process, it is possible to determine the presence/absence or material of the wafer. For example, in the case the digital-data string outputted from the digital-data-string generating section 20 agrees with the data string “0000000110000000” stored in the storage section 35, the absence of a wafer is determined.

In the case the digital-data string outputted from the digital-data-string generating section 20 agrees with the data string “0000000000000000” stored in the storage section 35, the presence of a silicon wafer is determined. The result thus determined is outputted to the control section 30.

The control section 30 is to generate and output a signal for controlling the semiconductor fabrication apparatus, depending upon a wafer determination result. Such a determination result can be realized, for example, as 2-bit data for the above embodiment. For example, it may be “00” in the absence of a wafer, “10” in the presence of a wafer whose material is silicon, or “11” in the presence of a wafer whose material is sapphire. Depending upon such a determination result, a control signal, for example, as in the following, can be outputted.

For example, when the wafer being transported is detected (when the left-end bit is “1” in the determination result), a signal for preparing wafer acceptance is then outputted to a wafer-processing mechanism. Or, when “11” is outputted as a determination result, even though a silicon wafer must be processed, a sapphire wafer is transported mistakenly. In such a case, a signal is generated for suspending the operation of the manufacturing apparatus, a signal for executing a transfer process, so as to not process the sapphire wafer is transmitted.

As described above, the apparatus and method, for determining a substrate in embodiment one of the invention, can detect a wafer presence/absence easily and positively. Furthermore, material can be detected as to the wafer thus detected. In the invention, it is satisfactory to cause the light from the light emitter to be obliquely incident upon the wafer and receive the refracted light reaching the light receiver through the wafer, by making use of the light refractivity of a wafer of a light-transmissive material. Accordingly, there is no need to decrease the incident angle of the light emitted from the light receiver to such an extent that the light is positively reflected upon the wafer surface, thus reducing the arrangement restriction of the light emitter and receiver. In ensuring wafer detection more positive, an increase in apparatus size can be moderated.

### Embodiment Two

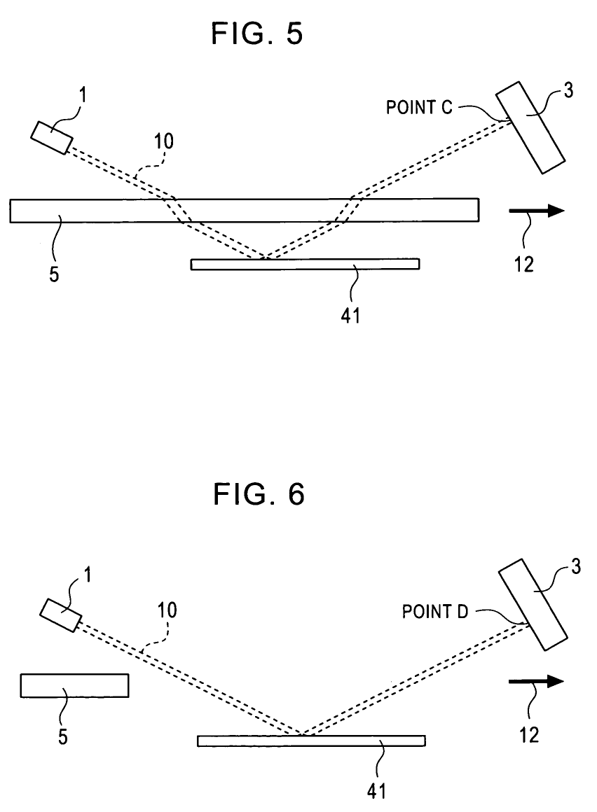

Using FIGS. 5 and 6, now described is a substrate detector and method for detecting a substrate according to embodiment two of the invention. FIG. 5 is a view explaining a substrate detector and method for detecting a substrate (in the presence of a substrate) in embodiment two of the invention. FIG. 6 is a view explaining a method for detecting a substrate (in the absence of a substrate) in embodiment two of the invention. In FIGS. 5 and 6, the structural elements having the same functions as those of embodiment one have the same numerals.

In FIG. 5, the substrate detector includes a light emitter 1 and a light receiver 3, similar to embodiment one. In embodiment two, a reflection plate 41 is further provided. The light emitter 1 is to emit light 10, for wafer detection, toward a transport path along which a wafer 5 is to be transported. As shown in FIG. 5, the light 10 from the light emitter 1 is obliquely incident upon the wafer 5 at the surface of the wafer. The reflection plate 41 reflects light such that the light 10 passed the transport path and again enters the wafer 5. The light receiver 3 is arranged in a position to receive the light reflected from the reflection plate 41 and passed again along the transport path of the wafer. Namely, in FIG. 5, the light emitter 1 and the light receiver 3 are arranged above the transport path while the reflection plate 41 is below the transport path. The light receiver 3 is structured with a plurality of sensors, similar to embodiment one. The plurality of sensors are arranged in series. The other structure is similar to that in embodiment one.

In this manner, embodiment two is arranged to cause light reflection by use of the reflection plate 41. With such an arrangement, for a wafer whose material is sapphire, light propagates through the wafer twice before reaching the light receiver 3 with a result that twice-refracted light reaches the light receiver 3. This can further improve the detection accuracy because the reception light on the light receiver 3 is to be shifted in position larger by twice refraction in comparison to once refraction. The substrate detecting method of the invention is now described in detail.

It is first assumed that a sapphire wafer that is transmissive to light is transported, as a wafer 5, in a direction 12 on the transport path as shown in FIG. 5. The light 10 emitted from the light emitter 1 obliquely entering the surface of the wafer 5. The light, obliquely entered the sapphire wafer 5 is refracted therein to propagate in the wafer 5, commensurate with the refractive index of the sapphire. The refracted light exits the wafer 5 at its backside and reaches the reflection plate 41. The reflection plate 41 reflects the light toward the backside of the wafer 5 so that the light can again enter the wafer 5. The reflected light again enters the wafer 5 obliquely and is reflected therein to propagate through the wafer 5 commensurate with the refractive index of the sapphire. The refracted light exits the wafer 5 at the surface of the wafer and reaches point C on the light receiver 3. At the light receiver 3, of a plurality of sensors, the sensor arranged at point C receives the light whereas the other sensors do not receive the light.

As shown in FIG. 6, when the wafer 5 is not transported to the transport path, the light 10 emitted from the light emitter 1 reaches reflection plate 41 without being blocked or refracted by the wafer 5. At the reflection plate 41, the light reaching the plate 41 is reflected to the light receiver 3 without being blocked or reflected by the wafer 5. Accordingly, the light reaches the point D, away from the point C, on the light receiver 3.

Although not shown, it is assumed that a silicon wafer not transmissive to light is being transported in the direction 12 on the transport path. The light 10 emitted from the light emitter 1 obliquely enters the surface of the wafer 5. However, silicon is not transmissive to light where the wafer has a thickness of approximately 600 μm-800 μm. With such a degree of thickness, the incident light 10 can be blocked almost positively. Accordingly, the light 10 emitted from the light emitter 1 is blocked by the wafer 5 so that there is no light to be reflected upon the reflection plate 41. Thus, no light reaches the light receiver 3.

In the case of a silicon wafer, the light emitted from the light emitter 1 can be considered to obliquely enter the surface of the wafer 5 and then reflect on the wafer surface. However, even in case the light 10 is reflected on the surface of the wafer 5, there is no problem if the light receiver 3 is arranged in a position so as not to receive the light reflected by the surface of the wafer 5. When the light reflected on the surface of the wafer 5 is assumed to reach the light receiver 3, a sensor position to receive such reflection light is determined the digital-data string of a silicon wafer among the digital-data string having stored in the storage section 35 in FIG. 3 should be adjusted by the component reflected on the wafer surface.

In this manner, detection is possible as to a presence/absence of a wafer 5 depending on a light-receiving state of the plurality of sensors on the light receiver 3 and a position of the sensor receiving the light. Furthermore, it is also possible to detect the material of the wafer 5. As for the processing of a result of the light reception at the light receiver 3, by using the digital-data string stored in the FIG. 3 storage section 35 in the case of embodiment two, processing is possible as in FIG. 3, similar to embodiment one.

As described above, the invention in embodiment two can exhibit a similar effect to that of embodiment one. Furthermore, the invention in embodiment two is expected to increase the difference between light reaching points on the light receiver in the case of no wafer and the case of a sapphire substrate (the difference in position between points C and D), larger than that in embodiment one (the difference in position between points A and B) by arrangement of the reflection plate and the double refraction, thus improving the accuracy of detection.

(Modification)

Although the invention was described in detail above, the invention is not limited to the embodiments.

For example, the invention, although exemplified by a wafer to be transported in the semiconductor fabrication apparatus, is not limited to a wafer to be handled by the semiconductor fabrication apparatus, as noted above.

In order to make the invention easy to understand, sixteen sensors were considered to constitute the light receiver 3, thereby providing sixteen samplings to obtain a 16-bit digital data string. However, this is not limitative and the number of sensors, the number of samplings and the number of bits of digital data may be increased and decreased as compared to those in the embodiments. At least two sensors are required in the embodiment wherein the digital data string requires 2 bits or more.

Furthermore, the embodiments described the substrate detector and method for detecting a substrate that is applied to the wafer transport path. However, this is not limitative but application is possible to a wafer processing apparatus in which the wafer is to be placed on a stage, for a resist application apparatus.

More specifically, in order to allow oblique incidence of light upon the surface of a wafer positioned on a stage, it is satisfactory to arrange the light emitter 1 of the invention in a manner to emit light toward an arrangement point of a peripheral edge of the substrate on the stage, and the light receiver 3 in a reception point of the light passing the arrangement point of the substrate peripheral edge. The “peripheral edge” referred to herein refers not to the wafer side surface or outer periphery but to a region, forming a notch (e.g. V-cutout) or orientation flat for use in wafer alignment, in the outer peripheral region and around the wafer surface. In the absence of a wafer, the light from the light emitter 1 reaches the light receiver 3 directly, similar to embodiment one. In the case of a silicon wafer placed on the stage, the light from the light emitter 1 is blocked by the wafer peripheral edge and the light does not reach the light receiver 3. When a sapphire wafer is placed on the stage, the light from the light emitter 1 is obliquely incident upon the wafer, to propagate in the wafer with a refraction depending on the light refractive index of the wafer, and hence the refracted light reaches the light receiver 3. Due to this, wafer presence/absence and type can be determined depending on the presence/absence and position of reception light at the light receiver 3, similar to embodiment one.

Furthermore, as applied to a wafer processing apparatus in which the wafer is to be rested on the stage, the following application is available.

In a state in which the wafer is placed on a stage, the stage is rotated (at least one rotation). During the rotation, detection is made as to the reception state, at the light receiver 3, of the light emitted from the light emitter 1. By observing a change in time of the state of light reception at the light receiver 3, it is possible to detect a break, notch or orientation flat in the wafer peripheral edge. Namely, the result of light reception at the light receiver 3 can be sampled at a predetermined time interval (e.g. at a time interval of one-n th of one rotation), to generate a plurality of digital data strings according to the passage of time. By observing the change in the bits of the digital data string, detection of a break, notch or orientation flat position is possible. In consideration of detection of an orientation-flat position, at least four (n≦4) samplings are required. For example, explaining it by exemplifying a silicon wafer, when examining a state of light reception in one wafer rotation at a wafer peripheral edge, light reception is only at the portion where the orientation flat is present. This accordingly results in continuing data strings of digital data string other than “0000000000000000”. By calculating an approximate time that continuing data strings other than “0000000000000000” occur after a start of rotation, it is possible to accurately aligning the orientation flat. In the case where there is an occurrence of non-continuous data strings other than “0000000000000000” in a position other than the orientation flat, it is possible to consider the possibility of light reception due to a break and hence to determine the existence of a break in the wafer. In the case where a notch is provided in place of the orientation flat, the notch can be detected by an occurrence of data strings other than continuous strings “0000000000000000” because the amount of break is larger as compared to that of an unintentional break. However, in a case of considering as an amount of a break in the wafer peripheral edge, the orientation flat is larger than the notch. Accordingly, when detecting a notch position, there would be a need to take a number of samplings as compared to the case to detect an orientation flat position. In the case where there is a break longer than the notch, by previously examining the number of times the data strings other than “0000000000000000” continue during detecting the notch, it is possible to determine whether it is a notch or a large break, depending upon whether or not the number of continuing data strings other than “0000000000000000”, obtained as a result of a detection process on the substrate peripheral edge, agrees with the number of continuing data strings other than “0000000000000000” obtained upon detection of a previously examined notch.

The embodiments have been described in which the wafer type also can be determined in addition to wafer/presence/absence. Where it is satisfactory to detect only a wafer presence/absence, the determination result as an output from the substrate determining section 25 may use a 1-bit signal representative of the substrate presence/absence.

In case of increasing the number of the digital data strings to be stored in the storage section 35, a larger number of substrate types can be determined without being limited to the two types, i.e. silicon and sapphire, as explained in the embodiment. In this case, because 2 bits are insufficient for a determination result, modification may be made to adapt for 3 or more bits.

This application is based on a Japanese patent application No. 2004-358706 which is incorporated herein by reference.

What is claimed is:

1. A substrate detector for optically detecting a substrate, the detector comprising:
a light emitter for emitting light toward a transport path of the substrate such that the light is obliquely incident on a surface of the substrate; and
a light receiver arranged in a position to receive the light that has passed the transport path of the substrate;
wherein the light receiver includes at least a plurality of sensors arranged in series.

2. A substrate detector according to claim 1, wherein the substrate detector includes a reflection plate, the reflection plate being arranged to reflect the light emitted from the light emitter and passed through the transport path so that reflected light is received by the light receiver through the transport path.

3. A substrate detector according to claim 1, wherein the light receiver includes a CCD line sensor, the CCD line sensor constituted by the plurality of sensors.

4. A substrate detector according to claim 1, wherein the plurality of sensors detect light to be converted into digital data by each of the sensors so that a substrate type can be detected depending upon a digital data string based on a detection result of the plurality of sensors.

5. A substrate detector according to claim 1, wherein the light emitter is arranged such that the light incident upon the surface of the substrate has an incident angle in a range of 30 degrees to 60 degrees.

6. A substrate detector for optically detecting a substrate, the detector comprising:
a light emitter for emitting light toward a position of a peripheral edge of the substrate mounted on a stage, the light being obliquely incident on a surface of the substrate; and
a light receiver arranged in a position to receive the light that has passed the position of the peripheral edge of the substrate;
wherein the light receiver includes at least a plurality of sensors arranged in series.

7. A substrate detector according to claim 6, wherein the light receiver includes a CCD line sensor, the CCD line sensor constituted by the plurality of sensors.

8. A substrate detector according to claim 6, wherein the plurality of sensors detect light to be converted into digital data by each of the sensors so that a substrate type can be detected depending upon a digital data string based on a detection result of the plurality of sensors.

9. A substrate detector according to claim 6, wherein the light emitter is arranged such that the light incident upon the surface of the substrate has an incident angle in a range of 30 degrees to 60 degrees.

10. A substrate detecting method for optically detecting a substrate, the method comprising:
a step of emitting light toward a transport path of the substrate from the light emitter so that the light is obliquely incident on a surface of the substrate;
a step of receiving light that has passed the transport path of the substrate by a light receiver includes at least a plurality of sensors arranged in series; and
a step of converting light received at the light receiver into digital data on a sensor-by-sensor basis and detecting a substrate presence/absence depending upon a converted digital data string.

11. A substrate detecting method according to claim 10, wherein a reflection plate reflects light emitted from the light emitter and passed through the transport path so that reflected light is received by the light receiver through the transport path.

12. A substrate detecting method according to claim 10, wherein substrate type, in addition to substrate presence/absence, is detected based on the digital data string.

13. A substrate detecting method according to claim 10, wherein the light incident upon the surface of the substrate has an incident angle in a range of 30 to 60 degrees.

14. A substrate detecting method for optically detecting a substrate, the method comprising:
a step of emitting light from a light emitter a position of a peripheral edge of the substrate mounted on a stage so that the light is obliquely incident on a surface of the substrate;
a step of receiving light that has passed the position of a peripheral edge of the substrate by a light receiver including at least a plurality of sensors arranged in series; and
a step of converting light received by the light receiver into digital data on a sensor-by-sensor basis and detecting a substrate presence/absence depending upon a converted digital data string.

15. A substrate detecting method according to claim 14, wherein the light receiver receives the light emitted from the light emitter in a time corresponding to at least one rotation of the stage, to store digital data strings obtained based on the received light from time to time, whereby a stage of the peripheral edge of the substrate is detected from the plurality of stored digital data strings.

16. A substrate detecting method according to claim 14, wherein substrate type, in addition to substrate presence/absence, is detected based on the digital data string.

17. A substrate detecting method according to claim 14, wherein light incident upon the surface of the substrate has an incident angle in a range of 30 degrees to 60 degrees.
